(19) United States
(12) Patent Application Publication
(10) Pub. No.: US 2026/0312669 A1
(43) Pub. Date: Oct. 8, 2026

(54) FACILITATING UE-CENTRIC PROCEDURES

(71) Applicant: Nokia Technologies Oy, Espoo (FI)

(72) Inventors: Matha DEGHEL, Massy (FR); Sami-Jukka HAKOLA, Oulu (FI); Keeth Saliya Jayasinghe LADDU, Espoo (FI)

(21) Appl. No.: 19/481,246

(22) PCT Filed: May 24, 2024
(86) PCT No.: PCT/IB2024/055089

§ 371 Date: Nov. 4, 2025

Related U.S. Application Data
(60) Provisional application No. 63/471,068, filed on Jun. 5, 2023.

(51) Int. Cl. H04B 7/08; H04B 7/06; H04L 5/00; H04W 72/044

(52) U.S. Cl. CPC H04B 7/088; H04B 7/06958; H04L 5/0094; H04W 72/046

(57) ABSTRACT

In accordance with an example embodiment of the present invention, an apparatus comprising: at least one processor; and at least one memory including computer program code, wherein the at least one memory and the computer program code are configured to, with the at least one processor, cause the apparatus at least to: receive, from a network device, information related to at least one condition, wherein the at least one condition is based at least partially on at least one of one or more best beams, one or more transmission configuration indication states, or one or more reference signals for the apparatus; determine, based on the information, that the at least one condition is fulfilled; and transmit, to the network device, information in response to determination that the at least one condition is fulfilled.

### RELATED APPLICATION

This application claims priority to U.S. provisional Application No. 63/471,068 filed Jun. 5, 2023, which is incorporated herein by reference in its entirety.

### TECHNICAL FIELD

The examples and non-limiting example embodiments relate generally to communications and, more particularly, to facilitating UE-centric BM and/or CSI related procedures.

### BACKGROUND

It is known for a user equipment to use beams for communication in a communication network.

### SUMMARY

Various aspects of examples of the invention are set out in the claims.

In accordance with one aspect, an apparatus comprising: at least one processor; and at least one memory including computer program code, wherein the at least one memory and the computer program code are configured to, with the at least one processor, cause the terminal device at least to: receive, from a network device, information related to at least one condition, wherein the at least one condition is based at least partially on at least one of one or more best beams, one or more transmission configuration indication states, or one or more reference signals for the apparatus; determine, based on the information, that the at least one condition is fulfilled; and transmit, to the network device, information in response to determination that the at least one condition is fulfilled.

In accordance with one aspect, a method comprising: receiving, from a network device, information related to at least one condition, wherein the at least one condition is based at least partially on at least one of one or more best beams, one or more transmission configuration indication states, or one or more reference signals; determining, based on the information, that the at least one condition is fulfilled; and transmitting, to the network device, information in response to determination that the at least one condition is fulfilled.

In accordance with one aspect, a non-transitory computer-readable medium comprising program instructions stored thereon for performing at least the following: receiving, from a network device, information related to at least one condition, wherein the at least one condition is based at least partially on at least one of one or more best beams, one or more transmission configuration indication states, or one or more reference signals; determining, based on the information, that the at least one condition is fulfilled; and transmitting, to the network device, information in response to determination that the at least one condition is fulfilled.

In accordance with one aspect, an apparatus comprising means for performing: receiving, from a network device, information related to at least one condition, wherein the at least one condition is based at least partially on at least one of one or more best beams, one or more transmission configuration indication states, or one or more reference signals for the apparatus; determining, based on the information, that the at least one condition is fulfilled; and transmitting, to the network device, information in response to determination that the at least one condition is fulfilled.

In accordance with one aspect, an apparatus comprising: at least one processor; and at least one memory including computer program code, wherein the at least one memory and the computer program code are configured to, with the at least one processor, cause the terminal device at least to: transmit, to a terminal device, information related to at least one condition, wherein the at least one condition is based at least partially on at least one of one or more best beams, one or more transmission configuration indication states, or one or more reference signals for the terminal device; receive, from the terminal device, information related to the at least one condition being fulfilled; and determine, based on the indication, that a channel state information reporting configuration is to be transmitted to the terminal device or a transmission configuration indication state is to be indicated to the terminal device.

In accordance with one aspect, a method comprising: transmitting, to a terminal device, information related to at least one condition, wherein the at least one condition is based at least partially on at least one of one or more best beams, one or more transmission configuration indication states, or one or more reference signals for the terminal device; receiving, from the terminal device, information related to the at least one condition being fulfilled; and determining, based on the indication, that a channel state information reporting configuration is to be transmitted to the terminal device or a transmission configuration indication state is to be indicated to the terminal device.

In accordance with one aspect, a non-transitory computer-readable medium comprising program instructions stored thereon for performing at least the following: transmitting, to a terminal device, information related to at least one condition, wherein the at least one condition is based at least partially on at least one of one or more best beams, one or more transmission configuration indication states, or one or more reference signals for the terminal device; receiving, from the terminal device, information related to the at least one condition being fulfilled; and determining, based on the indication, that a channel state information reporting configuration is to be transmitted to the terminal device or a transmission configuration indication state is to be indicated to the terminal device.

In accordance with one aspect, an apparatus comprising means for performing: transmitting, to a terminal device, information related to at least one condition, wherein the at least one condition is based at least partially on at least one of one or more best beams, one or more transmission configuration indication states, or one or more reference signals for the terminal device; receiving, from the terminal device, information related to the at least one condition being fulfilled; and determining, based on the indication, that a channel state information reporting configuration is to be transmitted to the terminal device or a transmission configuration indication state is to be indicated to the terminal device.

### BRIEF DESCRIPTION OF THE DRAWINGS

The foregoing aspects and other features are explained in the following description, taken in connection with the accompanying drawings.

FIG. 1 is a block diagram of one possible and non-limiting system in which the example embodiments may be practiced.

FIG. 2 illustrates DL beam management procedures.

FIG. 3 is an illustration of aspects of the herein described solution that may be performed by a user equipment.

FIG. 4 is an illustration of aspects of the herein described solution that may be performed by a user equipment.

FIG. 5 is an example apparatus configured to implement the examples described herein.

FIG. 6 shows a representation of an example of non-volatile memory media used to store instructions that implement the examples described herein.

FIG. 7 is an example method, based on the examples described herein.

FIG. 8 is an example method, based on the examples described herein.

### DETAILED DESCRIPTION OF EXAMPLE EMBODIMENTS

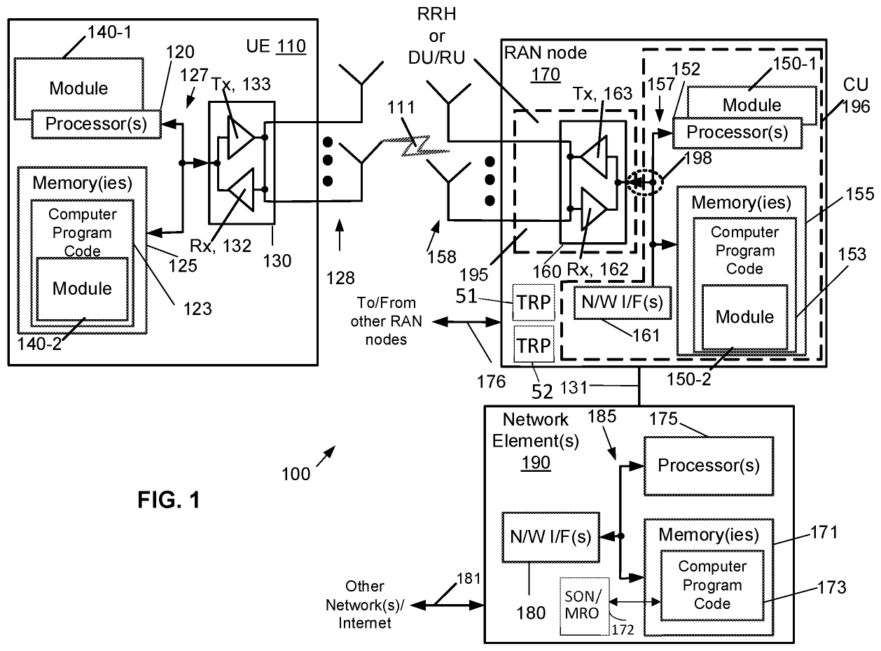

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access for wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, one or more memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

A RAN node/gNB can comprise one or more TRPs to which the methods described herein may be applied. FIG. 1 shows that the RAN node 170 comprises two TRPs, TRP 51 and TRP 52. The RAN node 170 may host or comprise other TRPs not shown in FIG. 1.

A relay node in NR is called an integrated access and backhaul node. A mobile termination part of the IAB node facilitates the backhaul (parent link) connection. In other words, the mobile termination part comprises the functionality which carries UE functionalities. The distributed unit part of the IAB node facilitates the so called access link (child link) connections (i.e. for access link UEs, and backhaul for other IAB nodes, in the case of multi-hop IAB). In other words, the distributed unit part is responsible for certain base station functionalities. The IAB scenario may follow the so called split architecture, where the central unit hosts the higher layer protocols to the UE and terminates the control plane and user plane interfaces to the 5G core network.

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (mobility management entity)/SGW (serving gateway) functionality. Such core network functionality may include SON (self-organizing/optimizing network) functionality. These are merely example functions that may be supported by the network element(s) 190, and note that both 5G and LTE functions might be supported. The RAN node 170 is coupled via a link 131 to the network element 190. The link 131 may be implemented as, e.g., an NG interface for 5G, or an SI interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. Computer program code 173 may include SON and/or MRO functionality 172.

The wireless network 100 may implement network virtualization, which is the process of combining hardware and software network resources and network functionality into a single, software-based administrative entity, or a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback devices having wireless communication capabilities, internet appliances including those permitting wireless internet access and browsing, tablets with wireless communication capabilities, head mounted displays such as those that implement virtual/augmented/mixed reality, as well as portable units or terminals that incorporate combinations of such functions. The UE 110 can also be a vehicle such as a car, or a UE mounted in a vehicle, a UAV such as e.g. a drone, or a UE mounted in a UAV. The user equipment 110 may be terminal device, such as mobile phone, mobile device, sensor device etc., the terminal device being a device used by the user or not used by the user.

UE 110, RAN node 170, and/or network element(s) 190, (and associated memories, computer program code and modules) may be configured to implement (e.g. in part) the methods described herein, including facilitating UE-centric BM and/or CSI related procedures. Thus, computer program code 123, module 140-1, module 140-2, and other elements/features shown in FIG. 1 of UE 110 may implement user equipment related aspects of the examples described herein. Similarly, computer program code 153, module 150-1, module 150-2, and other elements/features shown in FIG. 1 of RAN node 170 may implement gNB/TRP related aspects of the examples described herein. Computer program code 173 and other elements/features shown in FIG. 1 of network element(s) 190 may be configured to implement network element related aspects of the examples described herein.

Having thus introduced a suitable but non-limiting technical context for the practice of the example embodiments, the example embodiments are now described with greater specificity.

The examples described herein are related 3GPP New Radio (NR) physical layer development. NR is also referred to as a fifth generation (5G) radio system developed by 3GPP. More specifically, the methods described herein focus on UE-initiated beam management related procedures, which is a strong candidate topic for Rel-19 MIMO. While the focus is on NR Rel19 the proposed functionalities can be considered as input to coming 6G study items. 6G is about to introduce a new carrier frequency range for 7-20 GHz on which the operation can be considered as a mix of FR1 (0-6 GHZ) and FR2 (24-70 GHZ). That means that in the context of the examples described herein, FR3 is likely to have UEs operating with antenna arrays and analog beamforming components implemented with beam management procedures for gNB and UE beam alignment.

Beam Management defines a set of functionalities to assist the UE to set its RX and TX beams for downlink receptions and uplink transmissions, respectively. The functionalities can be categorized roughly according to four groups:
1. Beam indication: assist UE 110 to set its RX and TX beam properly for the reception of DL and transmission of UL, respectively.
2. Beam acquisition, measurements and reporting: procedures for providing gNB knowledge about feasible DL and UL beams for the UE.
3. Beam recovery: used for rapid link reconfiguration against sudden blockages, i.e. fast re-alignment of gNB and UE beams

4. Beam tracking and refinement: a set of procedures to refine gNB and UE side beams.

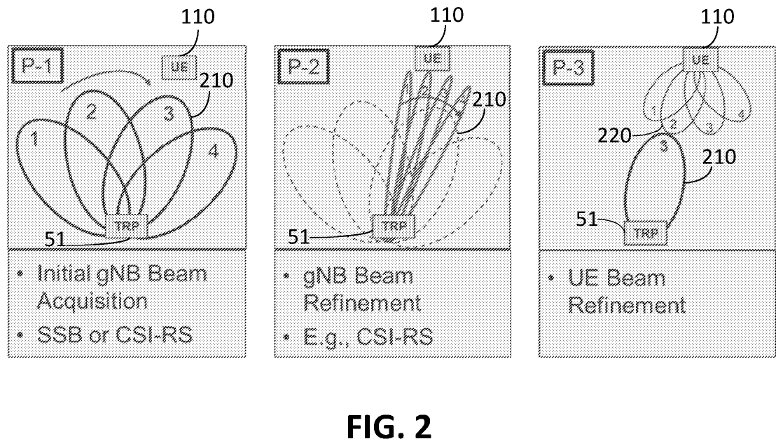

Regarding downlink beam management and especially for beam acquisition, measurements and reporting (item 2 above), the following beam management procedures are supported within one or multiple TRPs (e.g. TRP 51 and/or TRP 52) of the serving cell (as also illustrated in FIG. 2):

P-1 (procedure 1): is used to enable UE measurement on different TRP Tx beams (e.g. TRP Tx beams 1, 2, 3, and 4 as shown in P-1) to support selection of TRP Tx beams and/or one or more UE Rx beams. For beamforming at TRP 51, measurement and selection typically includes an intra/inter-TRP Tx beam sweep from a set of different beams (e.g. TRP Tx beams 1, 2, 3, and 4 as shown in P-1). For beamforming at UE 110, measurement and selection typically includes a UE Rx beam sweep from a set of different beams.

P-2 (procedure 2): is used to enable UE measurement on different TRP Tx beams (e.g. TRP Tx beams 1, 2, 3, and 4 as shown in P-2) to possibly change inter/intra-TRP Tx beam(s), from a possibly smaller set of beams for beam refinement than in P-1. Note that P-2 can be a special case of P-1. As shown in FIG. 2, the TRP Tx beams 1, 2, 3, and 4 shown in P-2 are intra-beams of the beam 3 (210) shown for P-1. Beam 3 (210) is shown as a dashed oval in P-2.

P-3 (procedure 3): is used to enable UE measurement on the same TRP Tx beam to change the UE Rx beam in the case UE uses beamforming. Thus as shown in FIG. 2, UE 110 may measure TRP Tx beam 3 (210) and then select UE Rx beam 2 (220) based on the measurement of the TRP Tx beam 3 (210).

Regarding downlink beam indication a quasi-colocation (QCL) indication functionality has been defined. The principle to receive certain a physical signal or physical channel is: the UE is either configured with or the UE implicitly determines a source or reference RS that the UE has received and measured earlier which defines how to set the RX beam for the reception of the downlink (target) physical signal or channel to be received. To provide UE 110 with QCL characteristics for the target signal to be received a transmission configuration indication (TCI) framework has been defined. Using the TCI framework, the UE 110 can be configured with one or more TCI states to provide UE 110 with one or more source reference signals (RSs) for determining QCL characteristics. Each TCI state includes one or two source RSs that provide UE QCL TypeA, TypeB, TypeC and/or TypeD parameters. Different types provide the parameters as follows:
QCL-TypeA: {Doppler shift, Doppler spread, average delay, delay spread}
QCL-TypeB: {Doppler shift, Doppler spread}
QCL-TypeC: {Doppler shift, average delay}
QCL-TypeD: {Spatial Rx parameter}

A reference signal (RS) as described herein may be a synchronization signal block (SSB), a channel state information reference signal (CSI-RS), a tracking reference signal (TRS), or a demodulation reference signal (DMRS), etc.

In uplink, the UE 110 is provided a parameter called spatial relation info providing a spatial source RS based on which the UE determines the uplink transmit beam. The spatial source RS can be a DL RS (SSB or CSI-RS) or UL RS (SRS). For each PUCCH and SRS resource, gNB 170 provides explicitly a spatial source while for PUSCH indirect indication is provided (1-2 immediately following):
1. PUSCH scheduled using DCI format 0_0, where spatial source is the same as with a certain PUCCH resource.
2. PUSCH scheduled using DCI format 0_1, where spatial source is the same as indicated one or more SRS resources: one SRS resource is indicated in a codebook based transmission scheme, and one or multiple SRS resources are indicated in a non-codebook based transmission scheme.

Rel16 introduced a default spatial relation for dedicated PUCCH and/or SRS (except SRS with usage=‘beamManagement’ and SRS with usage=‘nonCodeBook’ and configured with associated CSI-RS) where, if spatial relation is not configured in FR2 the UE determines spatial source as follows: in case when one or more control resource sets (CORESETs) are configured on the CC, the UE determines the TCI state and/or QCL assumption of the control resource set (CORESET) with the lowest ID, or, in case when any CORESETs are not configured on the CC, the UE determines the activated TCI state with the lowest ID applicable to the PDSCH in the active DL-BWP of the CC.

Furthermore, Rel16 introduced a default spatial relation for PUSCH scheduled by DCI format 0_0 where UE 110 determines the spatial relation as follows (1-2):
1. When there is no PUCCH resources configured on the active UL BWP CC, the default spatial relation is the TCI state and/or QCL assumption of the CORESET with the lowest ID, and the default pathloss RS is the QCL-TypeD RS of the same TCI state and/or QCL assumption of the CORESET with the lowest ID.
2. When there is no PUCCH resources configured on the active UL BWP CC in FR2 and in RRC-connected mode, the default spatial relation is the TCI state and/or QCL assumption of the CORESET with the lowest ID.

The default pathloss RS is the QCL-TypeD RS of the same TCI state and/or QCL assumption of the CORESET with the lowest ID.

Rel17 is introducing a unified TCI framework meaning that TCI states so far providing QCL assumptions for the reception of DL signals and channels would be used also to provide spatial sources for the transmission of UL signals and channels to determine a UL TX spatial filter. Furthermore, the unified TCI framework defines the concept of indicated TCI state. That means that one or multiple (in case of multi-TRP for instance) of the configured TCI states is or are indicated one or more TCI states at a time. The indicated TCI state can be a joint DL and UL TCI state or separate DL TCI states and separate UL TCI states. Indicated TCI state provides QCL source (DL) and spatial source (UL) for the set of downlink signals and channels and for the set of uplink signals and channels, respectively. In Rel17 there can be one indicated joint DL and UL or one indicated DL and one indicated UL TCI state for the UE.

The unified TCI framework is extended in Rel18 so that there can be then multiple indicated DL and UL TCI states.

Rel-15 provides support for both UE non-group and group-based beam reporting schemes in TS 38.214. The network can configure up to four CRIs and/or beams with L1-RSRP values to be reported (via PUCCH or PUSCH). Group based reporting is to provide network information about the network side beams (characterized by the reference signals) that the UE can receive simultaneously (either with single or multiple spatial filters a.k.a. panels).

In telecommunications design, there is big interest in supporting UE-initiated CSI reporting and beam switch. This would allow implementations to significantly reduce the overall latency of such operations, as well as to reduce the UL reporting overhead.

Rel-19 potential proposals include (1-4 immediately following):
1. UE-initiated beam and/or channel state feedback update.
2. Faster beam acquisition: L1-measurement burden increasing due to multi-cell, L1 and/or L2 mobility etc. SSB correlation information can be used for faster beam acquisition.
Reporting overhead can be reduced by UE triggered reporting.
3. UE-initiated beam operations can help to enhance FR2 operations, for example, beam selection at a UE event—e.g., the UE requests “best” beams not associated with DL RSs, and where the UE initiates or triggers beam measurement and reporting.
4. UE triggered or event-triggered LI beam measurement and/or reporting.

As previously indicated, a strong candidate for Rel-19 MIMO discussions is the objective on UE-initiated CSI reporting and/or update, including beam reporting, and/or beam or TCI state switch.

One important aspect that would need to be defined for such UE-initiated operation are the conditions and procedures that the UE should follow in order to determine and/or detect a need for CSI or beam reporting and/or update and/or beam switch. Hence, the examples described herein mainly focus on those aspects, with special focus on the corresponding conditions/events.

As it relates to the examples described herein, the best beam may be the beam with a higher L1-RSRP (compared to other beams), and the best beam pair may be the beam pair where the first beam of the beam pair and/or the second beam of the beam pair has the highest L1-RSRP (compared to other pairs).

In the herein described solution:

UE 110 receives a configuration for determining or detecting at least one event or condition that is at least partially based on best beams or preferred beams, TCI states, and/or reference signals such as downlink reference signals.

UE 110 determines that at least one condition or event that is based on best beams or preferred beams, TCI states, and/or reference signals such as downlink reference signals is satisfied or has occurred. The UE 110 may then provide the gNB 170 with information related to this at least one condition or event.

The at least one condition or event comprises one or more of the following (1-7):
1. A change of or in at least one of N best beams or preferred beams or CRIS (CSI-RS resource indicators or SSB resource indicators). These N beams or CRIs correspond to the beams or CRIs that the UE 110 would select and report to the gNB 170, if configured to do so. The number of beams (denoted as N) may be greater than or equal to 1. If Rel-17 or Rel-18 (or even Rel-15) group-based beam reporting is configured, then the at least one condition or event comprises a change of at least one of N best beam pairs or preferred beam pairs or CRIs indicating CSI-RS resource pairs. These pairs may correspond to the pairs that the UE 110 would select and report to the gNB 170 if configured to do so.
2. The best beam or preferred beam or at least one of the N best beams or preferred beams has a L1-RSRP or L1-SINR, or any other CSI quantity that becomes lower or higher than a threshold. If Rel-17 or Rel-18 group-based beam reporting is configured, then the at least one condition or event comprises the best beam pair or preferred beam pair or at least one of the N best beam pairs or preferred beam pairs has a L1-RSRP or L1-SINR, or any other CSI quantity, that becomes lower or higher than a threshold.

3. An average of L1-RSRP or any other CSI quantity e.g., over one or more of the N best beams or CRIs or preferred beams or CRIs has changed more than a certain value or becomes lower or higher than a threshold.
4. A change in the measurement value of the RS corresponding to the current indication TCI state compared to either option 1 or option 2. Option 1 is a measurement value of the RS corresponding to any of the activated TCI states. Option 2 is a measurement value of the RS in the pool of the RSs configured for the measurements (measurement in general could be L1-RSRP, L1-SINR, CQI, or any other physical layer measurement quantity).
5. If for one or more indicated or active TCI states, a corresponding CSI quantity or CSI quantities, such as L1-RSRP or L1-RSRPs, becomes higher or lower than a threshold.
6. If for one or more of indicated TCI states, active TCI states, UL TCI states, or joint TCI states, the corresponding one or more MPE values is or are below or above a threshold.
7. If at least one preferred capability value set index or UE panel has changed.

Any of the above conditions or events may be defined to be valid if it is satisfied for a given or configured period of time. This period may be represented by a timer, where the UE may start or restart the timer once at least one of the above conditions or events is satisfied or has occurred. And the UE may consider the condition or event valid only if the condition is satisfied until the timer expires. Alternatively, or additionally, any of the above conditions or events may be defined to be valid if it is satisfied for a number of consecutive times, where this number may be configured e.g., via RRC or indicated via MAC CE or DCI. Alternatively, or additionally, any of the above conditions or events may be defined to be valid if it is satisfied for a number of times within a period of time.

Any of the above conditions or events may be defined per group or set of CSI-RS resources or TCI states or beams or reference signals (SSBs, CSI-RSs, TRS, DMRS etc.). Each group or set of CSI-RS resources or TCI states or beams or reference signals may correspond to or be associated with a CORESETPoolIndex or PCI or SRS resource set, or a TRP, etc. It is noted that measurements related to any of the above conditions or events may be performed based on DMRS of DL channels, such as PDSCH or PDCCH, where the UE may be configured to perform such measurements based on at least one of: PDCCH(s) or PDSCH(s) corresponding to or scheduled by one or more CORESETs, PDCCH(s) or PDSCH(s) corresponding to or scheduled by one or more search space sets, PDSCH(s) corresponding to one or more PDSCH configurations, PDCCH(s) corresponding to one or more PDCCH configurations, PDSCH(s) or PDCCH(s) corresponding to or scheduled by one or more DCI formats, PDCCH(s) or PDSCH(s) on one or more carriers or BWPs (bandwidth parts), PDSCH(s) corresponding to a given MCS (modulation and coding scheme) value(s), PDSCH(s) corresponding to a given time domain and/or frequency domain allocation(s), or PDCCH(s) with a given aggregation level(s).

The above conditions may be jointly or separately defined or configured for DL and UL.

When reference is made to layer 1 (L1), layer 3 (L3) may also be applicable. For example, the at least one condition may be that the best beam or preferred beam or at least one of the N best beams or preferred beams has a L3-RSRP or L3-SINR that becomes lower or higher than a threshold.

A beam may be corresponding to or be represented by: a spatial filter, an UL beam, a DL beam, a TCI state, a quasi-colocation information, a reference signal (SSB, CSI-RS), an SRS resource, an SRS resource indicator, or an SRS resource set.

The UE 110 may receive at least one configuration, e.g., via RRC or MAC CE, for determining or detecting at least one of the above conditions or events.

Any of the (above or below) suggested thresholds, values, time period, timer, offset, number of times, etc. may be configured or indicated to the UE, via RRC, MAC CE and/or DCI, either separately or as part of another configuration.

UE 110 may then provide information to the network regarding any of the above conditions/events. This information may be informing the gNB 170 of any of the above events. Specifically, informing the gNB 170 of the event and/or of the change that has occurred. Alternatively, the information may trigger or initiate CSI or beam reporting or may trigger or initiate a TCI state switch.

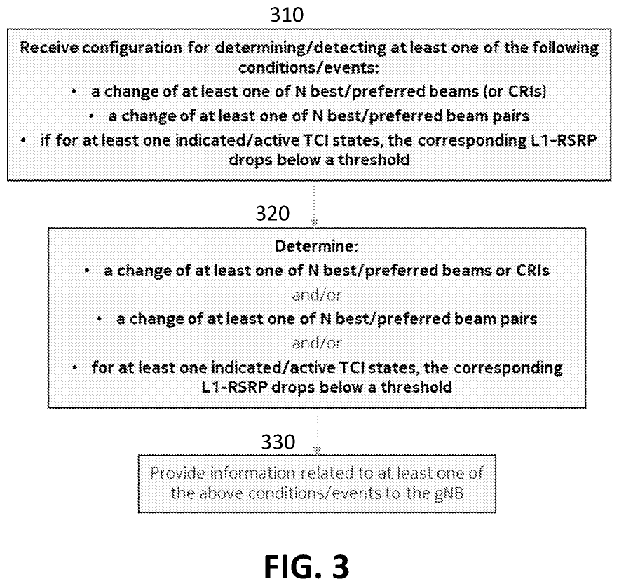

Referring to FIG. 3, example UE operations include:
310: receive configuration for determining at least one event or condition that is at least partially based on measured best and/or preferred beams, TCI states, and/or reference signals. At 310, UE 110 receives a configuration for determining or detecting at least one of the following conditions or events: a change of at least one of N best or preferred beams (or CRIs), a change of at least one of N best or preferred beam pairs, and if for at least one indicated or active TCI state, the corresponding L1-RSRP drops below a threshold.
320: determine that the at least one condition or event is satisfied or has occurred. At 320, the UE 110 determines: a change of at least one N best or preferred beams or CRIS and/or a change of at least one of N best or preferred beam pairs and/or for at least one indicated or active TCI state, whether the corresponding L1-RSRP drops below a threshold.
330: transmit to the gNB 170 information related to the at least one condition or event. At 330, UE 110 provides information related to at least one of the above conditions or events to the gNB 170.

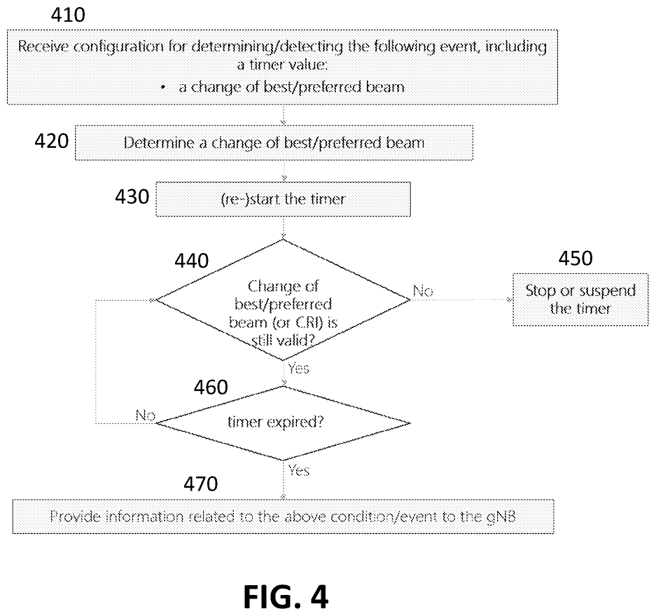

FIG. 4 is an illustration of aspects of the herein described solution that may be performed by a user equipment. At 410, the UE 110 receives a configuration for determining or detecting the following event, including a timer value: a change of a best beam or preferred beam. At 420, the UE 110 determines a change of a best beam or preferred beam (or CRI). At 430, the UE 110 starts or restarts the timer. At 440, the UE 110 determines whether the change of the best beam or preferred beam (or CRI) is still valid. If at 440 the UE 110 determines that the change of the best or preferred beam (or CRI) is not still valid (e.g. “No”), the method transitions to 450. If at 440 the UE 110 determines that the change of the best beam or preferred beam (or CRI) is still valid (e.g. “Yes”), the method transitions to 460. At 450, the UE stops or suspends the timer. At 460, the UE determines whether the timer expired. If at 460 the UE determines that the timer has not expired (e.g. “No”), the method transitions to 440. If at 460 the UE determines that the timer has expired (e.g. “Yes”), the method transitions to 470. At 470, the UE 110 provides information related to the condition or event to the gNB 170.

The aspects described herein may be contributed to Rel-19 MIMO (pre-)discussions. The herein described mechanisms improve current 3GPP functionalities and are standard related. Thus, the examples described herein may be relevant to 3GPP specifications.

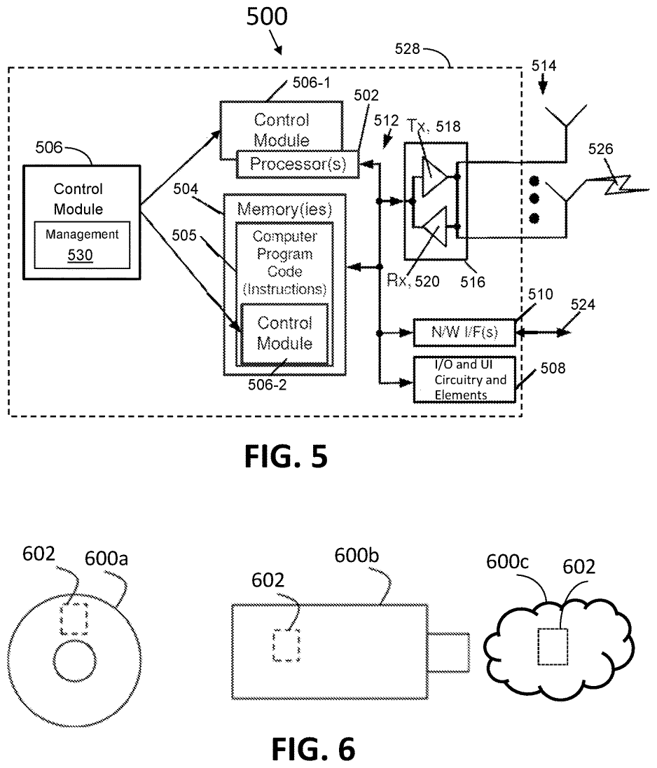

FIG. 5 is an example apparatus 500, which may be implemented in hardware, configured to implement the examples described herein. The apparatus 500 comprises at least one processor 502 (e.g. an FPGA and/or CPU), one or more memories 504 including computer program code 505, the computer program code 505 having instructions to carry out the methods described herein, wherein the at least one memory 504 and the computer program code 505 are configured to, with the at least one processor 502, cause the apparatus 500 to implement circuitry, a process, component, module, or function (implemented with control module 506) to implement the examples described herein, including facilitating UE-centric BM and/or CSI related procedures. The memory 504 may be a non-transitory memory, a transitory memory, a volatile memory (e.g. RAM), or a non-volatile memory (e.g. ROM). Management 530 of the control module implements the herein described aspects related to facilitating UE-centric BM and/or CSI related procedures.

The apparatus 500 includes a display and/or I/O interface 508, which includes user interface (UI) circuitry and elements, that may be used to display aspects or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 500 includes one or more communication e.g. network (N/W) interfaces (I/F(s)) 510. The communication I/F(s) 510 may be wired and/or wireless and communicate over the Internet/other network(s) via any communication technique including via one or more links 524. The link(s) 524 may be the link(s) 131 and/or 176 from FIG. 1. The link(s) 131 and/or 176 from FIG. 1 may also be implemented using transceiver(s) 516 and corresponding wireless link(s) 526. The communication I/F(s) 510 may comprise one or more transmitters or one or more receivers.

The transceiver 516 comprises one or more transmitters 518 and one or more receivers 520. The transceiver 516 and/or communication I/F(s) 510 may comprise standard well-known components such as an amplifier, filter, frequency-converter, (de)modulator, and encoder/decoder circuitries and one or more antennas, such as antennas 514 used for communication over wireless link 526.

The control module 506 of the apparatus 500 comprises one of or both parts 506-1 and/or 506-2, which may be implemented in a number of ways. The control module 506 may be implemented in hardware as control module 506-1, such as being implemented as part of the one or more processors 502. The control module 506-1 may be implemented also as an integrated circuit or through other hardware such as a programmable gate array. In another example, the control module 506 may be implemented as control module 506-2, which is implemented as computer program code (having corresponding instructions) 505 and is executed by the one or more processors 502. For instance, the one or more memories 504 store instructions that, when executed by the one or more processors 502, cause the apparatus 500 to perform one or more of the operations as described herein. Furthermore, the one or more processors 502, the one or more memories 504, and example algorithms (e.g., as flowcharts and/or signaling diagrams), encoded as instructions, programs, or code, are means for causing performance of the operations described herein.

The apparatus 500 to implement the functionality of control 506 may be UE 110, RAN node 170 (e.g. gNB), or network element(s) 190. Thus, processor 502 may correspond to processor(s) 120, processor(s) 152 and/or processor(s) 175, memory 504 may correspond to one or more memories 125, one or more memories 155 and/or one or more memories 171, computer program code 505 may correspond to computer program code 123, computer program code 153, and/or computer program code 173, control module 506 may correspond to module 140-1, module 140-2, module 150-1, and/or module 150-2, and communication I/F(s) 510 and/or transceiver 516 may correspond to transceiver 130, antenna(s) 128, transceiver 160, antenna(s) 158, N/W I/F(s) 161, and/or N/W I/F(s) 180. Alternatively, apparatus 500 and its elements may not correspond to either of UE 110, RAN node 170, or network element(s) 190 and their respective elements, as apparatus 500 may be part of a self-organizing/optimizing network (SON) node or other node, such as a node in a cloud. Apparatus 500 may also correspond to TRP 51 or TRP 52.

The apparatus 500 may also be distributed throughout the network (e.g. 100) including within and between apparatus 500 and any network element (such as a network control element (NCE) 190 and/or the RAN node 170 and/or UE 110.

Interface 512 enables data communication and signaling between the various items of apparatus 500, as shown in FIG. 5. For example, the interface 512 may be one or more buses such as address, data, or control buses, and may include any interconnection mechanism, such as a series of lines on a motherboard or integrated circuit, fiber optics or other optical communication equipment, and the like. Computer program code (e.g. instructions) 505, including control 506 may comprise object-oriented software configured to pass data or messages between objects within computer program code 505. The apparatus 500 need not comprise each of the features mentioned, or may comprise other features as well. The various components of apparatus 500 may at least partially reside in a common housing 528, or a subset of the various components of apparatus 500 may at least partially be located in different housings, which different housings may include housing 528.

FIG. 6 shows a schematic representation of non-volatile memory media 600a (e.g. computer/compact disc (CD) or digital versatile disc (DVD)) and 600b (e.g. universal serial bus (USB) memory stick) and 600c (e.g. cloud storage for downloading instructions and/or parameters 602 or receiving emailed instructions and/or parameters 602) storing instructions and/or parameters 602 which when executed by a processor allows the processor to perform one or more of the steps of the methods described herein.

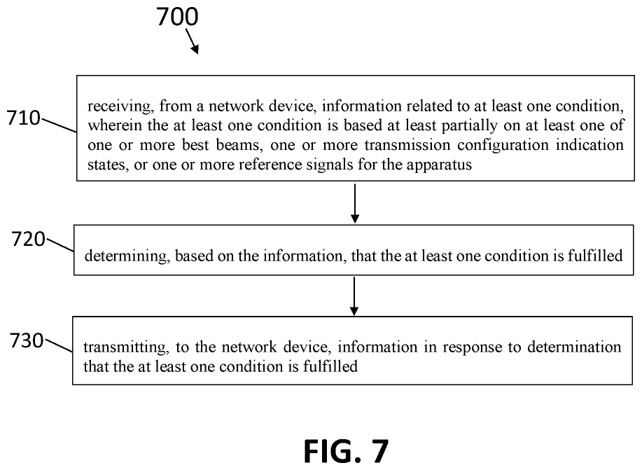

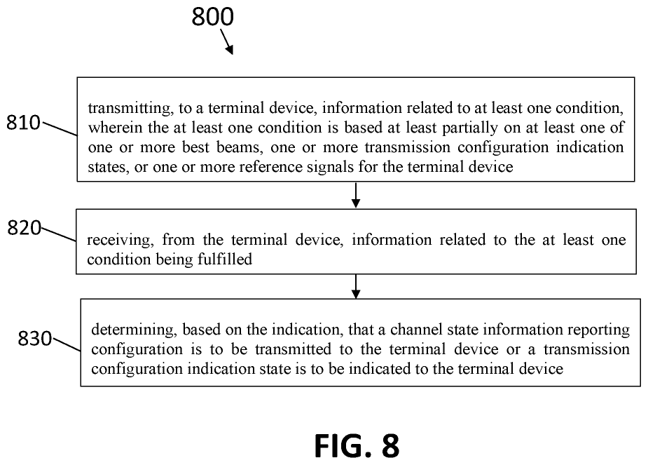

FIG. 7 is an example method 700, based on the example embodiments described herein. At 710, the method includes receiving, from a network device, information related to at least one condition, wherein the at least one condition is based at least partially on at least one of one or more best beams, one or more transmission configuration indication states, or one or more reference signals for the apparatus. At 720, the method includes determining, based on the information, that the at least one condition is fulfilled. At 730, the method includes transmitting, to the network device, information in response to determination that the at least one condition is fulfilled. Method 700 may be performed with UE 110 or apparatus 500 FIG. 8 is an example method 800, based on the example embodiments described herein. At 810, the method includes transmitting, to a terminal device, information related to at least one condition, wherein the at least one condition is based at least partially on at least one of one or more best beams, one or more transmission configuration indication states, or one or more reference signals for the terminal device. At 820, the method includes receiving, from the terminal device, information related to the at least one condition being fulfilled. At 830, the method includes determining, based on the indication, that a channel state information reporting configuration is to be transmitted to the terminal device or a transmission configuration indication state is to be indicated to the terminal device. Method 800 may be performed with RAN node 170, TRP 51, TRP 52, one or more network element(s) 190, or apparatus 500.

The following examples are provided and described herein.

Example 1. An apparatus comprising: at least one processor; and at least one memory storing instructions that, when executed by the at least one processor, cause the apparatus at least to: receive, from a network device, information related to at least one condition, wherein the at least one condition is based at least partially on at least one of one or more best beams, one or more transmission configuration indication states, or one or more reference signals for the apparatus; determine, based on the information, that the at least one condition is fulfilled; and transmit, to the network device, information in response to determination that the at least one condition is fulfilled.

Example 2. The apparatus of example 1, wherein the at least one condition comprises at least one of: a change in a best beam, or a change in a best channel state information reference signal resource indicator (CRI), or a change in a best synchronization signal block resource indicator (SSBRI), or a change in a set of one or more best beams, or a change in a set of one or more best channel state information reference signal resource indicators (CRIs), or a change in a set of one or more best synchronization signal block resource indicators (SSBRIs), or a change of at least one of a set of best beam pairs or channel state information reference signal resource indicator (CRI) pairs, or a reference signal received power (RSRP) value associated with a best beam or at least one of the set of best beams or at least one beam pair is lower or higher than a threshold or changes more than an offset value, or a value related to RSRP values associated with at least part of the set of best beams or at least part of least one beam pair is lower or higher than a threshold or changes more than an offset value, or a measurement value of at least one reference signal (RS) associated with a transmission configuration indication (TCI) state is higher or lower than a measurement value of a reference signal (RS) associated with another TCI state by a threshold, or an RSRP value associated with a TCI state is lower or higher than a threshold or changes more than an offset value, or a maximum permissible exposure (MPE) value associated with a TCI state or with a reference signal is lower or higher than a threshold or changes more than an offset value, or a change of at least one capability value set index, or at least one pathloss measurement or value for one or more reference signals is lower or higher than a threshold or changes more than an offset value, or a channel quality indicator value or a rank value, determined based on at least one reference signal, is lower or higher than a threshold or changes more than an offset value, or a change of a best pair or of at least one pair of reference signals that the apparatus can receive simultaneously, or a change of a best pair or of at least one pair of reference signals based on which the apparatus determines uplink spatial filters that the apparatus can apply simultaneously for uplink transmissions, or a change of an uplink transmit filter or of a preferred uplink transmit filter, or a need for a beam refinement or uplink spatial filter refinement.

Example 3. The apparatus of any of examples 1 to 2, wherein the information comprises a timer related to the at least one condition.

Example 4. The apparatus of example 3, wherein the instructions, when executed by the at least one processor, cause the apparatus at least to: determine that the at least one condition is fulfilled, based on the timer.

Example 5. The apparatus of any of examples 3 to 4, wherein the instructions, when executed by the at least one processor, cause the apparatus at least to: start or restart the timer once the at least one condition is fulfilled or a period of time after the at least one condition is fulfilled, or stop or suspend the timer once the at least one condition is not fulfilled.

Example 6. The apparatus of any of examples 1 to 5, wherein the information comprises at least one of: a threshold or an offset value related to reference signal received power (RSRP), or a threshold or an offset value related to a measurement value of a reference signal (RS), or a threshold or an offset value related to maximum permissible exposure (MPE) values, or a threshold or an offset value related to a channel quality indicator value or a rank value.

Example 7. The apparatus of any of examples 1 to 6, wherein the at least one condition is related to beam management.

Example 8. The apparatus of any of examples 1 to 7, wherein the at least one condition is related to channel state information (CSI) measurement and/or reporting and/or channel state information reference signal (CSI-RS) transmission.

Example 9. The apparatus of any of examples 1 to 8, wherein the at least one condition is based at least partially on at least one of one or more best beam pairs or groups, or one or more of reference signal pairs or groups.

Example 10. The apparatus of any of examples 1 to 9, wherein the one or more transmission configuration indication states comprises one or more uplink (UL) transmission configuration indication (TCI) states, one or more downlink (DL) TCI states, or one or more joint UL and DL TCI states.

Example 11. The apparatus of any of examples 1 to 10, wherein the information transmitted to the network device comprises at least one of: an indication indicating the at least one condition is fulfilled, channel state information (CSI) beam reporting, transmission configuration indication (TCI) state switch, TCI state preference, or triggering or requesting beam refinement.

Example 12. The apparatus of any of examples 1 to 11, wherein the at least one condition is defined per group or per set of channel state information reference signal (CSI-RS) resources, transmission configuration indication (TCI) states, beams, or reference signals, wherein the reference signals comprise synchronization signal blocks or channel state information reference signals.

Example 13. The apparatus of example 12, wherein the reference signals comprise synchronization signal blocks (SSBs) or channel state information reference signals (CSI-RSs).

Example 14. The apparatus of any of examples 12 to 13, wherein a group or a set of the channel state information reference signal (CSI-RS) resources, transmission configuration indication (TCI) states, beams, or reference signals correspond to or are associated with a control resource set pool index, a physical cell identifier (PCI), a sounding reference signal (SRS) resource set, or a transmission reception point.

Example 15. An apparatus comprising: at least one processor; and at least one memory storing instructions that, when executed by the at least one processor, cause the apparatus at least to: transmit, to a terminal device, information related to at least one condition, wherein the at least one condition is based at least partially on at least one of one or more best beams, one or more transmission configuration indication states, or one or more reference signals for the terminal device; receive, from the terminal device, information related to the at least one condition being fulfilled; and determine, based on the indication, that a channel state information reporting configuration is to be transmitted to the terminal device or a transmission configuration indication state is to be indicated to the terminal device.

Example 16. The apparatus of example 15, wherein the at least one condition comprises at least one of: a change in a best beam, or a change in a best channel state information reference signal resource indicator (CRI), or a change in a best synchronization signal block resource indicator (SSBRI), or a change in a set of one or more best beams, or a change in a set of one or more best channel state information reference signal resource indicators (CRIs), or a change in a set of one or more best synchronization signal block resource indicators (SSBRIs), or a change of at least one of a set of best beam pairs or channel state information reference signal resource indicator (CRI) pairs, or a reference signal received power (RSRP) value associated with a best beam or at least one of the set of best beams or at least one beam pair is lower or higher than a threshold or changes more than an offset value, or a value related to RSRP values associated with at least part of the set of best beams or at least part of at least one beam pair is lower or higher than a threshold or changes more than an offset value, or a measurement value of at least one reference signal (RS) associated with a transmission configuration indication (TCI) state is higher or lower than a measurement value of a reference signal (RS) associated with another TCI state by a threshold, or an RSRP value associated with a TCI state is lower or higher than a threshold or changes more than an offset value, or a maximum permissible exposure (MPE) value associated with a TCI state or with a reference signal is lower or higher than a threshold or changes more than an offset value, or a change of at least one capability value set index, or at least one pathloss measurement or value for one or more reference signals is lower or higher than a threshold or changes more than an offset value, or a channel quality indicator value or a rank value, based on at least one reference signal, is lower or higher than a threshold or changes more than an offset value, or a change of a best pair or of at least one pair of reference signals that the apparatus can transmit simultaneously, or a change of a best pair or of at least one pair of reference signals based on which uplink spatial filters can be applied simultaneously for uplink receptions, or a change of an uplink transmit filter or of a preferred uplink transmit filter, or a need for a beam refinement or uplink spatial filter refinement.

Example 17. The apparatus of any of examples 15 to 16, wherein the information comprises at least one of: a timer related to the at least one condition, or a threshold or an offset value related to reference signal received power (RSRP), or a threshold or an offset value related to a measurement value of a reference signal (RS), or a threshold or an offset value related to maximum permissible exposure (MPE) values, or a threshold or an offset value related to a channel quality indicator value or a rank value.

Example 18. The apparatus of any of examples 15 to 17, wherein the at least one condition is related to beam management.

Example 19. The apparatus of any of examples 15 to 18, wherein the at least one condition is related to channel state information (CSI) measurement and/or reporting and/or channel state information reference signal (CSI-RS) transmission.

Example 20. The apparatus of any of examples 15 to 19, wherein the at least one condition is based at least partially on at least one of one or more best beam pairs or groups, or one or more of reference signal pairs or groups.

Example 21. The apparatus of any of examples 15 to 20, wherein the one or more transmission configuration indication states comprises one or more uplink (UL) transmission configuration indication (TCI) states, one or more downlink (DL) TCI states, or one or more joint UL and DL TCI states.

Example 22. The apparatus of any of examples 15 to 21, wherein the information received from the terminal device comprises at least one of: an indication indicating the at least one condition is fulfilled, channel state information (CSI) beam reporting, transmission configuration indication (TCI) state switch, TCI state preference, or triggering or requesting beam refinement.

Example 23. The apparatus of any of examples 15 to 22, wherein the at least one condition is defined per group or per set of channel state information reference signal (CSI-RS) resources, transmission configuration indication (TCI) states, beams, or reference signals, wherein the reference signals comprise synchronization signal blocks or channel state information reference signals.

Example 24. The apparatus of example 23, wherein the reference signals comprise synchronization signal blocks (SSBs) or channel state information reference signals (CSI-RSs).

Example 25. The apparatus of any of examples 23 to 24, wherein a group or a set of the channel state information reference signal (CSI-RS) resources, transmission configuration indication (TCI) states, beams, or reference signals correspond to or are associated with a control resource set pool index, a physical cell identifier (PCI), a sounding reference signal (SRS) resource set, or a transmission reception point.

Example 26. A method comprising: receiving, from a network device, information related to at least one condition, wherein the at least one condition is based at least partially on at least one of one or more best beams, one or more transmission configuration indication states, or one or more reference signals for the apparatus; determining, based on the information, that the at least one condition is fulfilled; and transmitting, to the network device, information in response to determination that the at least one condition is fulfilled.

Example 27. A method comprising: transmitting, to a terminal device, information related to at least one condition, wherein the at least one condition is based at least partially on at least one of one or more best beams, one or more transmission configuration indication states, or one or more reference signals for the terminal device; receiving, from the terminal device, information related to the at least one condition being fulfilled; and determining, based on the indication, that a channel state information reporting configuration is to be transmitted to the terminal device or a transmission configuration indication state is to be indicated to the terminal device.

Example 28. An apparatus comprising: means for receiving, from a network device, information related to at least one condition, wherein the at least one condition is based at least partially on at least one of one or more best beams, one or more transmission configuration indication states, or one or more reference signals for the apparatus; means for determining, based on the information, that the at least one condition is fulfilled; and means for transmitting, to the network device, information in response to determination that the at least one condition is fulfilled.

Example 29. An apparatus comprising: means for transmitting, to a terminal device, information related to at least one condition, wherein the at least one condition is based at least partially on at least one of one or more best beams, one or more transmission configuration indication states, or one or more reference signals for the terminal device; means for receiving, from the terminal device, information related to the at least one condition being fulfilled; and means for determining, based on the indication, that a channel state information reporting configuration is to be transmitted to the terminal device or a transmission configuration indication state is to be indicated to the terminal device.

Example 30. A non-transitory program storage device readable by a machine, tangibly embodying a program of instructions executable by the machine for performing operations, the operations comprising: receiving, from a network device, information related to at least one condition, wherein the at least one condition is based at least partially on at least one of one or more best beams, one or more transmission configuration indication states, or one or more reference signals for the apparatus; determining, based on the information, that the at least one condition is fulfilled; and transmitting, to the network device, information in response to determination that the at least one condition is fulfilled.

Example 31. A non-transitory program storage device readable by a machine, tangibly embodying a program of instructions executable by the machine for performing operations, the operations comprising: transmitting, to a terminal device, information related to at least one condition, wherein the at least one condition is based at least partially on at least one of one or more best beams, one or more transmission configuration indication states, or one or more reference signals for the terminal device; receiving, from the terminal device, information related to the at least one condition being fulfilled; and determining, based on the indication, that a channel state information reporting configuration is to be transmitted to the terminal device or a transmission configuration indication state is to be indicated to the terminal device.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memories as described herein may be implemented using any suitable data storage technology, such as semiconductor based memory devices, flash memory, magnetic memory devices and systems, optical memory devices and systems, non-transitory memory, transitory memory, fixed memory and removable memory. The memories may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memories that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment. Accordingly, this description is intended to embrace all such alternatives, modifications and variances which fall within the scope of the appended claims.

The following acronyms and abbreviations that may be found in the specification and/or the drawing figures are given as follows (the abbreviations and acronyms may be appended with each other or with other characters using e.g. a dash, hyphen, slash, or number, and may be case insensitive):
3GPP third generation partnership project
4G fourth generation
5G fifth generation
5GC 5G core network
6G sixth generation
AMF access and mobility management function
ASIC application-specific integrated circuit
BM beam management
BWP bandwidth part
CC component carrier
CD compact/computer disc
CE control element
CORESET control resource set
CPU central processing unit
CQI channel quality indicator
CRI CSI-RS resource indicator
CSI channel state information
CSI-RS channel state information reference signal
CU central unit or centralized unit
DCI downlink control information
DL downlink
DMRS demodulation reference signal
DSP digital signal processor
DVD digital versatile disc
eNB evolved Node B (e.g., an LTE base station)
EN-DC E-UTRAN new radio-dual connectivity
en-gNB node providing NR user plane and control plane protocol terminations towards the UE, and acting as a secondary node in EN-DC
E-UTRA evolved universal terrestrial radio access, i.e., the LTE radio access technology
E-UTRAN E-UTRA network
F1 interface between the CU and the DU
FPGA field-programmable gate array
FR frequency range
gNB base station for 5G/NR, i.e., a node providing NR user plane and control plane protocol terminations towards the UE, and connected via the NG interface to the 5GC
IAB integrated access and backhaul
ID identifier
I/F interface
I/O input/output
L1 layer 1
L2 layer 2
L3 layer 3
LMF location management function
LTE long term evolution (4G)
MAC medium access control
MCS modulation and coding scheme
MIMO multiple input multiple output
MME mobility management entity
MPE maximum permissible exposure
MRO mobility robustness optimization
N a number with an integer part and/or fractional part (e.g. N is equal to 2 or 2.5)
NCE network control element
ng or NG new generation
ng-eNB new generation eNB
NG-RAN new generation radio access network
NR new radio
N/W network
PCI physical cell ID
PDA personal digital assistant
PDCCH physical downlink control channel
PDCP packet data convergence protocol
PDSCH physical downlink shared channel
PHY physical layer
PUCCH physical uplink control channel
PUSCH physical uplink shared channel
QCL quasi co-location
RAM random access memory
RAN radio access network
Rel release
RLC radio link control
ROM read-only memory
RRC radio resource control
RS reference signal
RSRP reference signal received power
RU radio unit
Rx receiver or reception
SDAP service data adaptation protocol
SGW serving gateway
SINR signal to interference and noise ratio
SMF session management function
SON self-organizing/optimizing network
SRS sounding reference signal
SSE synchronization signal block, or synchronization signal and physical broadcast channel block
SSBRI synchronization signal block resource indicator
TCI transmission configuration indication, transmission coordination indication, transmission configuration indicator, or transmission coordination indicator
TRP transmission reception point
TRS tracking reference signal
Tx transmitter or transmission
UAV unmanned aerial vehicle
UE user equipment (e.g., a wireless, typically mobile device)
UI user interface
UL uplink
UPF user plane function
USB universal serial bus
X2 network interface between RAN nodes and between RAN and the core network
Xn network interface between NG-RAN nodes

1-31. (canceled)

32. An apparatus, comprising:
at least one processor; and
at least one memory storing instructions that, when executed by the at least one processor, cause the apparatus at least to:
receive, from a network device, information related to at least one condition, wherein the at least one condition is based at least partially on at least one of one or more best beams, one or more transmission configuration indication states, or one or more reference signals for the apparatus;
determine, based on the information, that the at least one condition is fulfilled; and
transmit, to the network device, information in response to determination that the at least one condition is fulfilled.

33. The apparatus of claim 32, wherein the at least one condition comprises at least one of:
a change in a best beam, or
a change in a best channel state information reference signal resource indicator (CRI), or
a change in a best synchronization signal block resource indicator (SSBRI), or
a change in a set of one or more best beams, or
a change in a set of one or more best channel state information reference signal resource indicators (CRIs), or
a change in a set of one or more best synchronization signal block resource indicators (SSBRIs), or
a change of at least one of a set of best beam pairs or channel state information reference signal resource indicator (CRI) pairs, or
a reference signal received power (RSRP) value associated with a best beam or at least one of the set of best beams or at least one beam pair is lower or higher than a threshold or changes more than an offset value, or
a value related to RSRP values associated with at least part of the set of best beams or at least part of least one beam pair is lower or higher than a threshold or changes more than an offset value, or
a measurement value of at least one reference signal (RS) associated with a transmission configuration indication (TCI) state is higher or lower than a measurement value of a reference signal (RS) associated with another TCI state by a threshold, or
an RSRP value associated with a TCI state is lower or higher than a threshold or changes more than an offset value, or
a maximum permissible exposure (MPE) value associated with a TCI state or with a reference signal is lower or higher than a threshold or changes more than an offset value, or
a change of at least one capability value set index, or
at least one pathloss measurement or value for one or more reference signals is lower or higher than a threshold or changes more than an offset value, or
a channel quality indicator value or a rank value, determined based on at least one reference signal, is lower or higher than a threshold or changes more than an offset value, or
a change of a best pair or of at least one pair of reference signals that the apparatus can receive simultaneously, or
a change of a best pair or of at least one pair of reference signals based on which the apparatus determines uplink spatial filters that the apparatus can apply simultaneously for uplink transmissions, or
a change of an uplink transmit filter or of a preferred uplink transmit filter, or
a need for a beam refinement or uplink spatial filter refinement.

34. The apparatus of claim 32, wherein the information comprises a timer related to the at least one condition.

35. The apparatus of claim 34, wherein the instructions, when executed by the at least one processor, cause the apparatus at least to:
determine that the at least one condition is fulfilled, based on the timer.

36. The apparatus of claim 34, wherein the instructions, when executed by the at least one processor, cause the apparatus at least to:
start or restart the timer once the at least one condition is fulfilled or a period of time after the at least one condition is fulfilled, or
stop or suspend the timer once the at least one condition is not fulfilled.

37. The apparatus of claim 32, wherein the information comprises at least one of:
a threshold or an offset value related to reference signal received power (RSRP), or
a threshold or an offset value related to a measurement value of a reference signal (RS), or
a threshold or an offset value related to maximum permissible exposure (MPE) values, or
a threshold or an offset value related to a channel quality indicator value or a rank value.

38. The apparatus of claim 32, wherein the at least one condition is related to beam management.

39. The apparatus of claim 32, wherein the at least one condition is related to channel state information (CSI) measurement and/or reporting and/or channel state information reference signal (CSI-RS) transmission.

40. The apparatus of claim 32, wherein the at least one condition is based at least partially on at least one of one or more best beam pairs or groups, or one or more of reference signal pairs or groups.

41. The apparatus of claim 32, wherein the one or more transmission configuration indication states comprises one or more uplink transmission configuration indication (TCI) states, one or more downlink TCI states, or one or more joint uplink and downlink TCI states.

42. The apparatus of claim 32, wherein the information transmitted to the network device comprises at least one of: an indication indicating the at least one condition is fulfilled, channel state information (CSI) beam reporting, transmission configuration indication (TCI) state switch, TCI state preference, or triggering or requesting beam refinement.

43. The apparatus of claim 32, wherein the at least one condition is defined per group or per set of channel state information reference signal (CSI-RS) resources, transmission configuration indication (TCI) states, beams, or reference signals, wherein the reference signals comprise synchronization signal blocks or channel state information reference signals.

44. The apparatus of claim 32, wherein the reference signals comprise synchronization signal blocks (SSBs) or channel state information reference signals (CSI-RSs).

45. The apparatus of claim 32, wherein a group or a set of the channel state information reference signal (CSI-RS) resources, transmission configuration indication (TCI) states, beams, or reference signals correspond to or are associated with a control resource set pool index, a physical cell identifier (PCI), a sounding reference signal (SRS) resource set, or a transmission reception point.

46. An apparatus comprising:
at least one processor; and
at least one memory storing instructions that, when executed by the at least one processor, cause the apparatus at least to:
transmit, to a terminal device, information related to at least one condition, wherein the at least one condition is based at least partially on at least one of one or more best beams, one or more transmission configuration indication states, or one or more reference signals for the terminal device;
receive, from the terminal device, information related to the at least one condition being fulfilled; and
determine, based on the indication, that a channel state information reporting configuration is to be transmitted to the terminal device or a transmission configuration indication state is to be indicated to the terminal device.

47. The apparatus of claim 46, wherein the at least one condition comprises at least one of:
a change in a best beam, or
a change in a best channel state information reference signal resource indicator (CRI), or
a change in a best synchronization signal block resource indicator (SSBRI), or
a change in a set of one or more best beams, or
a change in a set of one or more best channel state information reference signal resource indicators (CRIs), or
a change in a set of one or more best synchronization signal block resource indicators (SSBRIs), or
a change of at least one of a set of best beam pairs or channel state information reference signal resource indicator (CRI) pairs, or
a reference signal received power (RSRP) value associated with a best beam or at least one of the set of best beams or at least one beam pair is lower or higher than a threshold or changes more than an offset value, or
a value related to RSRP values associated with at least part of the set of best beams or at least part of at least one beam pair is lower or higher than a threshold or changes more than an offset value, or
a measurement value of at least one reference signal (RS) associated with a transmission configuration indication (TCI) state is higher or lower than a measurement value of a reference signal (RS) associated with another TCI state by a threshold, or
an RSRP value associated with a TCI state is lower or higher than a threshold or changes more than an offset value, or
a maximum permissible exposure (MPE) value associated with a TCI state or with a reference signal is lower or higher than a threshold or changes more than an offset value, or
a change of at least one capability value set index, or
at least one pathloss measurement or value for one or more reference signals is lower or higher than a threshold or changes more than an offset value, or
a channel quality indicator value or a rank value, based on at least one reference signal, is lower or higher than a threshold or changes more than an offset value, or
a change of a best pair or of at least one pair of reference signals that the apparatus can transmit simultaneously, or
a change of a best pair or of at least one pair of reference signals based on which uplink spatial filters can be applied simultaneously for uplink receptions, or
a change of an uplink transmit filter or of a preferred uplink transmit filter, or
a need for a beam refinement or uplink spatial filter refinement.

48. The apparatus of claim 46, wherein the information comprises at least one of:
a timer related to the at least one condition, or
a threshold or an offset value related to reference signal received power (RSRP), or
a threshold or an offset value related to a measurement value of a reference signal (RS), or
a threshold or an offset value related to maximum permissible exposure (MPE) values, or
a threshold or an offset value related to a channel quality indicator value or a rank value.

49. The apparatus of claim 46, wherein the at least one condition is related to channel state information (CSI) measurement and/or reporting and/or channel state information reference signal (CSI-RS) transmission.

50. The apparatus of claim 46, wherein the reference signals comprise synchronization signal blocks (SSBs) or channel state information reference signals (CSI-RSs).

51. A method comprising:
receiving, from a network device, information related to at least one condition, wherein the at least one condition is based at least partially on at least one of one or more best beams, one or more transmission configuration indication states, or one or more reference signals for a terminal device;
determining, based on the information, that the at least one condition is fulfilled; and
transmitting, to the network device, information in response to determination that the at least one condition is fulfilled.
